(19) United States
(12) Patent Application Publication
(10) Pub. No.: US 2005/0068163 A1
(43) Pub. Date: Mar. 31, 2005

(54) Vehicle side mounted signal light retrofit kit

(76) Inventor: David Nevin, Calgary (CA)

Correspondence Address: David Nevin, 3 Country Lane Bay, Calgary, AB, T3Z 1J8, CA

(21) Appl. No.: 10/670,293

(22) Filed: Sep. 26, 2003

(51) Int. Cl. B60Q 1/34

(52) U.S. Cl. 340/475; 362/487; 340/471

(57) ABSTRACT

The present invention is a Retro-fit side-signal light kit that is relatively inexpensive. The kit includes two light housings with automotive bulbs and lenses, a curved flange base to wrap around the front fender of a vehicle, with wires imbedded and suitable wire connectors at their distal ends. The base has a self-adhesive strip on the back to securely mount the light to the front fenders of a vehicle directly above and behind the front wheels. The side-signal light kit is designed to be easily installed by the average vehicle owner without technical knowledge or special tools and without permanent damage or alteration to the vehicle these lights are to be actuated by the respective lights of the vehicles present signal light system, when their wires are connected to the backside of the existing front signal lights. Thus facilitating better visibility and safer turns and lane changes.

This Application Claims Priority Of Provisional Patent No. 60/412,568 Sep. 23, 2002

### FIELD OF THE INVENTION

This invention relates to the components of side signal lights for vehicles, which are made available as a kit to easy retrofit vehicles without this feature to thereby enhance their safety and appearance.

### BACKGROUND OF THE INVENTION

The owners of older model vehicles must do without many of the safety features which have become standard features on vehicles that are but a few years newer. To obtain such new features one must either purchase a more modern vehicle, at a substantial cost, or engage a mechanic, again at some cost, to install the desired safety feature, provided such feature is available. Where such after market safety equipment is available, such as turn signal lights which are intended to be mounted on the side of a vehicle front fender, generally rearwardly of the wheel, installation generally requires a level of expertise well beyond that of the average automobile owner. Such installation generally requires drilling through the metal fender of the vehicle for wiring access and securing the signal light housing with screws. Such procedures although not technically difficult do require a certain level of expertise and the proper tools.

In the prior art the applicant is aware of U.S. Pat. No. 5,072,340 which issued Dec. 10, 1999 to Jones for Signal Lamps Visible to Driver. Jones discloses omnidirectional signal lamps mounted at each corner of a vehicle so as to be visible to the driver of that vehicle either directly or through rearwardly viewing mirrors. Screws passing from the inside of the vehicle body secure a circular shaped rim positioned on the external surface of the vehicle body. A hole is drilled through the vehicle body for the passage of electrical wiring.

The applicant is also aware of U.S. Pat. No. 5,996,073 to Walton. Walton discloses an Automotive Front and Side Brake/Running/Turn Signal Light. These lights are mounted below the line of sight of the vehicle operator and comprise a light that is illuminated when the automobile ignition is on and a second, which is activated when the braking system is actuated. A third light may be intermittently actuated by the turn signals of the vehicle.

Installation of such lights as revealed in the prior art appears to require substantial permanent alteration to a vehicle, such as drilling and attaching mounting screws through the body of the vehicle. In addition the cost of such after market items may be prohibitive to most owners of older vehicles where such are not factory installed. Further the expertise to properly wire an accessory having two or more lights would require expertise beyond that expected from the average vehicle owner.

It is an object of this invention to provide an automobile accessory side signal light kit containing a pair of signal light housing with associated lenses, bulbs and wiring which will be relatively inexpensive to purchase and which can be easily installed on the side of the front fender of an automobile without the need for permanently damaging or altering the body of the vehicle and without the need for special tools. Generally such side signal lights are mounted between the front wheel and the leading edge of the front door so as to provide a clear visual indication of intended directional changes to both the drivers of other vehicles and pedestrians to whom the vehicles normal signal lights are obscured.

A further object is to provide a side signal light housing, which may be readily secured in a desired permanent position on the side portion of an automobile fender by vehicle owner having little installation expertise, without damage to the surface of the fender.

A further object is to provide wiring leads extending from each side signal light housing which are directed around the trailing edge of the front fender by a portion of the base of the signal light housing which can then be attached to the turn signal wiring of the automobile without the need special for tools or expertise.

### SUMMARY OF THE INVENTION

The present invention is a side signal light accessory kit which includes a pair of signal light housings, each having a base with attached light socket and bulb, a removable, generally hemispherically shaped lens and wiring attached to the light socket with suitable connectors at their distal ends for quickly connecting to the electrical wiring of the automobile turn signals.

The base has an upstanding rim, which frictionally accepts and retains the lens. A light socket is secured to the upper face of the base, which accepts an automobile light bulb. While the underside of the base has a self-adhesive surface generally covered by a pull-off protective strip. The trailing edge of the base is contoured so as to wrap around the trailing edge of the front fender and extends from the exterior to the interior surface of the fender. After installation of the signal light housing on the automobile, the electrical wiring is forwardly directed by the trailing edge of the base on the inner surface of the fender generally toward the front signal lights of the vehicle. The exposed ends of the electrical wires, remote from the side signal light base, are adapted for quick and easy connection to the automobile turn signal wiring by quick clips or the like.

The lens of the side signal light may be either clear or amber in color. Light bulbs are provided that are opposite in color to that of the lens to ensure the side signal lights are amber when illuminated.

In summary, the side signal light for mounting to an edge of an automobile fender includes a light housing containing a light fixture for an electrical light bulb, the light housing having a base plate and a light transmitting cover mounted thereto, a wrap-around flange mounted to one end of the base plate, the flange adapted for snug fitment around the edge of the fender, an electrical conduit electrically connected to the fixture and extending therefrom embedded in the flange so as to be disposed behind the edge of the fender when the housing and flange are mounted on the fender.

### FIVE CLAIMS, FIVE DRAWINGS

### BRIEF DESCRIPTION OF THE DRAWINGS

FIG. 1, is a left hand side view of an automobile with the side mounted signal lights secured in place.

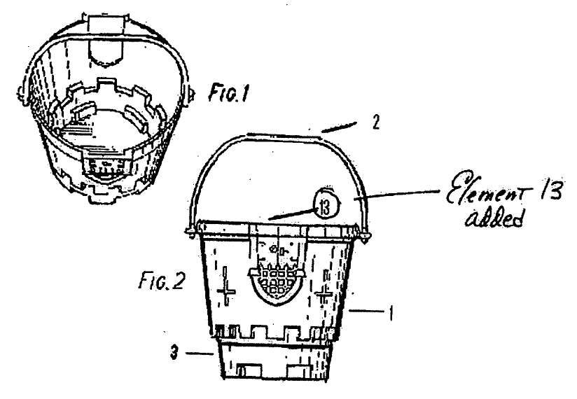

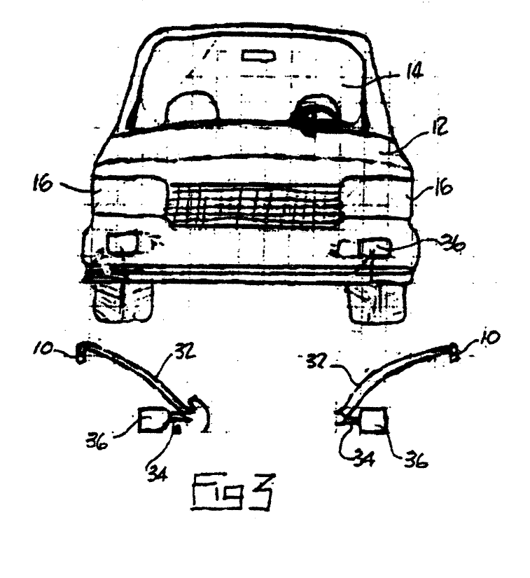

FIG. 2 is a right hand side view of an automobile with the side mounted signal lights secured in place.

FIG. 3 is a front view of an automobile with the vehicle turn signal and wiring removed, schematically illustrating typical attachment of the side signal lights.

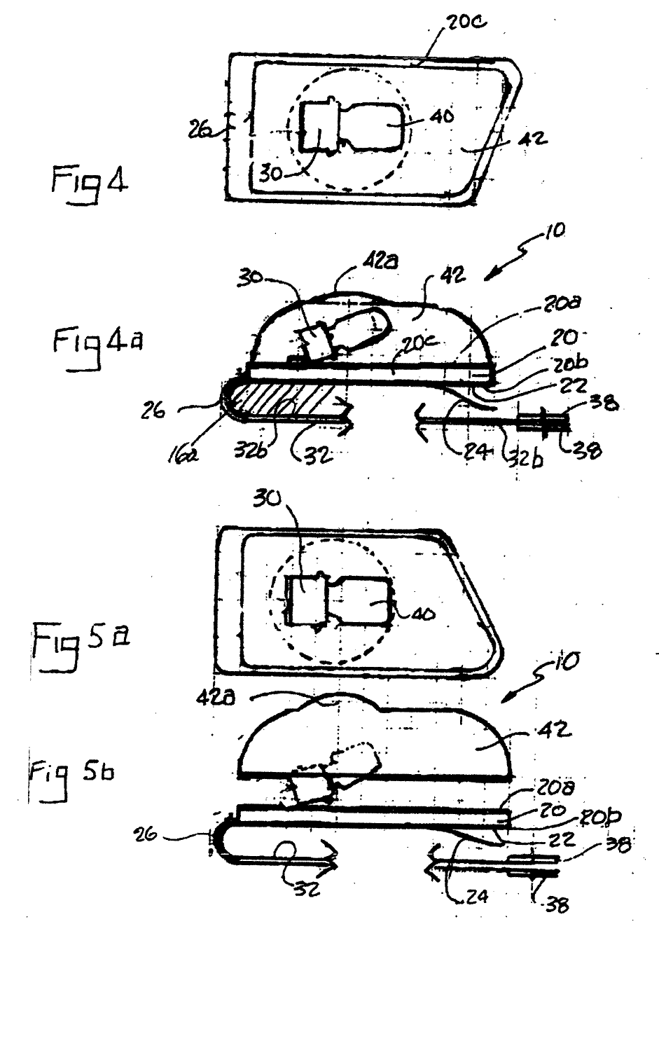

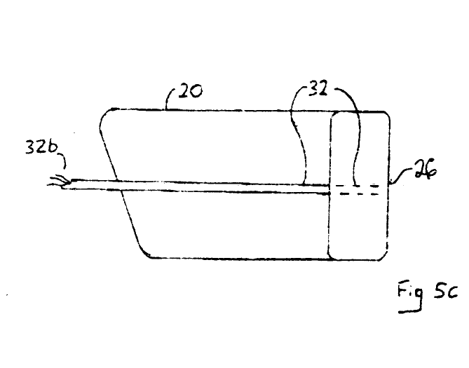

FIGS. 4 and 4a are front and side elevation view respectively of the side signal light mechanism according to the present invention.

FIGS. 5a and 5b are front and side, respectively partially exploded views of the side signal light.

FIG. 5c is a back view of the side signal light of FIG. 5a.

### DETAILED DESCRIPTION OF EMBODIMENTS OF THE INVENTION

With reference to the drawing figures, wherein similar characters of reference denote corresponding parts in each view, the side signal light assemblies 10 are positioned and mounted on an automobile 12 below the level of the windshield 14 on the sides of both front fenders 16 of a vehicle, generally at the trailing edges 16a of the fenders.

The side signal light accessory kit comprises two identical side light assemblies 10 each of which comprises a base 20 having outer and inner facing surfaces 20a and 20b respectively and an upstanding peripheral rim 20c. Outer surface 20b has an adhesive surface 22 which when pressed against a vehicle fender 16 will firmly adhere the base 20 t the fender. A peelable covering 24 normally protects adhesive surface 22 and is removed prior to fixing the base to a fender. The trailing edge 26 of base 20 is contoured so as to wrap around the trailing edge 16a of the front fenders 16. Base 20 may be reflective such as by chrome plating or similar means. Inner surface 20a of base 20 has a light socket 30 secured thereto.

Suitable electrical wiring 32 extends from socket 30 and is embedded within trailing edge 26 of base 20 and emerges as positive and negative leads 32b which can be attached in series to the automotive wiring 34 which activate the turn signals 26 of the automobile 12. Connection of the leads 32b to automotive wiring 34 is simplified by the provision of quick clips 38 or the like at the distal ends.

Light bulbs 40, which may be standard automotive bulbs, fit within light socket 30 and are illuminated when the vehicle turn signal is operated. A generally hemispherically shaped lens 42 having a light magnifying section 42a is removably secured to base 20. Bulb 40 for example may have a clear illuminated area while lens 42 is amber colored, however the color of the lens and bulb may be reversed provided that during operation the light emitted from the side mounted signal light is an amber color.

As will be apparent to those skilled in the art in the light of the foregoing disclosure, many alterations and modifications are possible in the practice of this invention without departing from the spirit or scope thereof.

1-5. (canceled)

6. A bucket with a handle.

7. A handle comprising an elongated wire.

8. The handle of claim 7 further comprising a plastic grip.

9. A bucket with a green blue handle.

10. The bucket of claim 9 wherein the handle is made of wood.

11. (canceled)

13. A bucket with plastic sides and bottom.
